(19) United States
(12) Patent Application Publication
(10) Pub. No.: US 2024/0383373 A1
(43) Pub. Date: Nov. 21, 2024

(54) POWER SUPPLY CONTROL DEVICE

(71) Applicant: YAZAKI CORPORATION, Tokyo (JP)

(72) Inventors: Ryoichi Murata, Makinohara-shi (JP); Sadaharu Okuda, Makinohara-shi (JP); Hayato Yamaguchi, Makinohara-shi (JP)

(21) Appl. No.: 18/658,951

(22) Filed: May 8, 2024

(30) Foreign Application Priority Data
May 15, 2023 (JP) 2023-079766

(51) Int. Cl. B60L 58/12; H02J 7/00

(52) U.S. Cl. CPC B60L 58/12; H02J 7/0063; H02J 7/00716; B60L 2240/549; B60L 2260/26

(57) ABSTRACT

In a power supply control device, a control unit is switchable between a drive mode, in which a drive current flows from a battery to load units and the control unit, a standby mode, in which the drive current is interrupted and a dark current flows, and an interruption mode, in which the dark current is interrupted. When a charge level of the battery detected by a battery sensor is lower than or equal to a dark current interruption threshold in the standby mode, a relay control unit of the control unit switches a relay to interrupt the dark current flowing from the battery to the load units and the control unit and switch from the standby mode to the interruption mode.

### CROSS-REFERENCE TO RELATED APPLICATION(S)

The present application claims priority to and incorporates by reference the entire contents of Japanese Patent Application No. 2023-079766 filed in Japan on May 15, 2023.

### BACKGROUND OF THE INVENTION

### 1. Field of the Invention

The present invention relates to a power supply control device.

### 2. Description of the Related Art

As a power supply control device, Japanese Patent Application Laid-open No. H11-334498 A, for example, describes a battery exhaustion prevention device that supplies, through a power supply line opening and closing unit, battery power to various loads that operate on battery power after an engine is stopped. The battery exhaustion prevention device includes a battery voltage detection unit that detects a battery voltage, a first threshold voltage storage unit that stores a voltage value corresponding to first remaining battery charge, a second threshold voltage storage unit that stores a voltage value corresponding to remaining battery charge smaller than the first remaining battery charge, a use state detection unit that detects a use state of a vehicle, an engine stop detection unit that detects a stop of an engine, a voltage comparison unit that, after the engine stop detection unit detects a stop of the engine, reads a threshold voltage from the first or second threshold voltage storage unit in accordance with the use state of the vehicle detected by the use state detection unit and that compares the threshold voltage with the battery voltage detected by the battery voltage detection unit, a power supply stopping unit that, if the voltage comparison unit determines that the battery voltage is lower than or equal to the threshold voltage, controls the power supply line opening and closing unit in such a way as to stop the supply of power to all the various loads. Japanese Patent Application Laid-open No. 2008-290604 A, Japanese Patent Application Laid-open No. 2008-179221 A, Japanese Patent Application Laid-open No. 2015-120465 A, and Japanese Patent Application Laid-open No. 2018-038116 A describe techniques relating to a power supply control device that controls a power supply.

Although the battery exhaustion prevention device described in the above Japanese Patent Application Laid-open No. H11-334498 A stops supplying power to all the loads including a dark current load if the battery voltage is lower than or equal to the threshold voltage, power is still supplied to an interruption control circuit including the power supply stopping unit in this case, and there is a possibility that the power is wasted.

### SUMMARY OF THE INVENTION

The present invention, therefore, has been made in view of the above, and aims to provide a power supply control device capable of appropriately controlling a power supply.

In order to achieve the above mentioned object, a power supply control device according to one aspect of the present invention includes a control unit that is configured to control power supplied from a battery mounted on a vehicle to a load unit by switching a power mode; a relay that is provided between the battery and the load unit and that is capable of interrupting power supplied from the battery to the load unit; a detection unit that detects a charge level of the battery; and a switch mechanism that switches the power mode separately from the switching of the power mode by the control unit, wherein the control unit is switchable between, as the switching of the power mode, a drive mode, in which a drive current for driving the load unit and the control unit flows from the battery to the load unit and the control unit, a standby mode, in which the drive current is interrupted and a dark current flows from the battery to the load unit and the control unit, and an interruption mode, in which the dark current flowing from the battery to the load unit and the control unit is interrupted, and, in a case where the charge level of the battery detected by the detection unit is lower than or equal to a predetermined dark current interruption threshold in the standby mode, the control unit switches the relay to interrupt the dark current flowing from the battery to the load unit and the control unit and switches from the standby mode to the interruption mode, and when pressed and turned on in the interruption mode, the switch mechanism switches the relay after the interruption without the control performed by the control unit to cause the dark current to flow from the battery to the load unit and the control unit and switch from the interruption mode to the standby mode.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a circuit diagram illustrating an example of configuration of a power supply control device according to an embodiment;

FIG. 2 is a diagram illustrating a dark current interruption threshold according to the embodiment;

FIG. 3 is a flowchart illustrating an example of operations performed by the power supply control device according to the embodiment;

FIG. 4 is a circuit diagram illustrating an example of configuration of a power supply control device according to a modification of the embodiment; and

FIG. 5 is a diagram illustrating an example of configuration of a switch mechanism according to another modification of the embodiment.

### DETAILED DESCRIPTION OF THE PREFERRED EMBODIMENTS

A mode (embodiment) for implementing the present invention will be described in detail with reference to the drawings. The present invention is not limited by contents described in the following embodiment. In addition, constituent elements described below include those that can be easily assumed by those skilled in the art and those that are substantially the same. Furthermore, configurations described below can be appropriately combined together. In addition, various omissions, substitutions, or changes in the configurations can be made without departing from the gist of the present invention.

A power supply control device 1 according to the embodiment will be described with reference to the drawings. The power supply control device 1 controls a battery B mounted on a vehicle and particularly controls a dark current on the basis of a charge level of the battery B in order to inhibit the charge level of the battery B from becoming zero. The power supply control device 1 will be described in detail hereinafter.

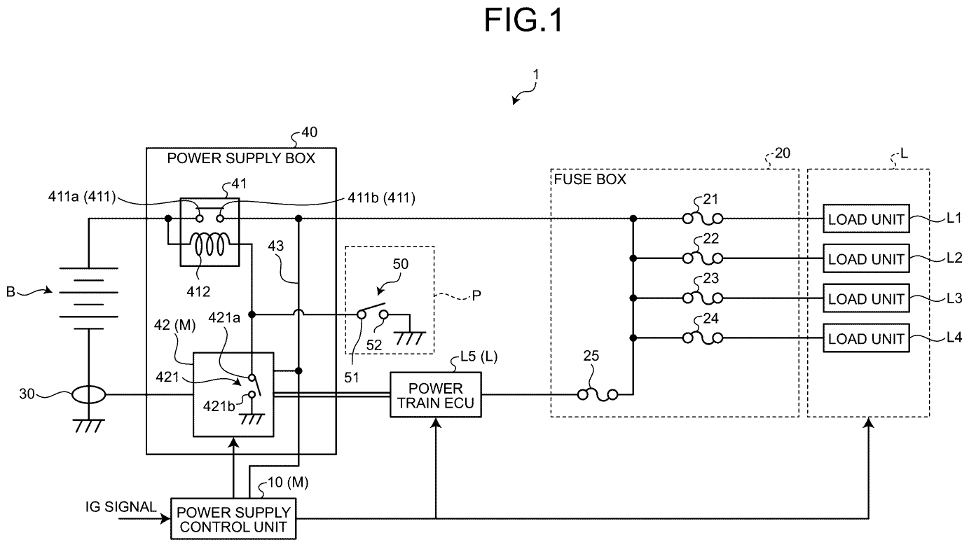

As illustrated in FIG. 1, for example, the power supply control device 1 includes a power supply control unit 10, a fuse box 20, a battery sensor 30 as a detection unit, a power supply box 40, and a switch mechanism 50. The power supply control unit 10 and a relay control unit 42, which will be described later, will also be referred to as a control unit M.

The power supply control unit 10 switches a power mode of the vehicle to control power supplied from the battery B of the vehicle to load units L. Here, the power supply control device 1 has a drive mode, a standby mode, and an interruption mode as power modes of the vehicle.

The drive mode is a mode in which a drive current for driving the load units L and the control unit M flows from the battery B to the load units L and the control unit M. That is, the drive mode is a mode in which the drive current flows from the battery B to the load units L and the control unit M when an ignition switch of the vehicle is turned on. In the drive mode, by receiving the drive current supplied from the battery B, the load units L and the control unit M enter a drive state, where the load units L and the control unit M can perform certain operations.

The standby mode is a mode in which the drive current is interrupted and a dark current flows from the battery B to the load units L and the control unit M. That is, the standby mode is a mode in which the dark current flows from the battery B to the load units L and the control unit M when the ignition switch of the vehicle is turned off. Here, the load units L include ones that need to be operated with low power even when the vehicle is parked. Examples of such load units L include a keyless receiver, a clock, a security device, a power train ECU, and the like. In the standby mode, by receiving the dark current supplied from the battery B, the load units L and the control unit M that operate with the dark current enter a standby state (low-power state) in which the load units L and the control unit M can perform standby operations.

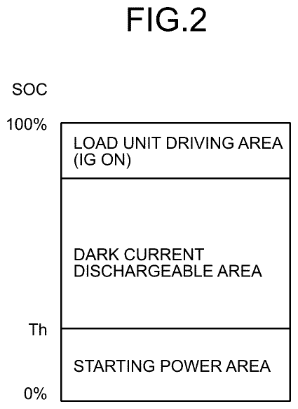

The interruption mode is a mode in which the drive current flowing from the battery B to the load units L and the control unit M is interrupted. That is, the interruption mode is a mode in which the dark current flowing from the battery B to the load units L and the control unit M is interrupted when the charge level of the battery B becomes lower than or equal to a predetermined dark current interruption threshold Th (refer to FIG. 2) in the standby mode. In the interruption mode, the dark current supplied from the battery B is interrupted, and the load units L and the control unit M enter a stop state, where the load units L and the control unit M stop the standby operations. FIG. 2 illustrates a starting power area, which is a power area secured for starting the vehicle, a dark current dischargeable area, which is an area where the dark current can be discharged, and a load unit drive area (IG on), which is an area where the load units L are driven, in accordance with the charge level (SOC) of the battery B. The dark current interruption threshold Th is set at a boundary between the dark current dischargeable area and the starting power area.

When the power supply control unit 10 receives an IG on signal (IG signal), which indicates that the ignition switch has been turned on, the power supply control unit 10 switches from the standby mode to the drive mode. Upon receiving the IG on signal, for example, the power supply control unit 10 activates the load units L and the relay control unit 42 in the standby state to establish the drive state. When the power supply control unit 10 receives an IG off signal (IG signal), which indicates that the ignition switch has been turned off, on the other hand, the power supply control unit 10 switches from the drive mode to the standby mode. Upon receiving the IG off signal, for example, the power supply control unit 10 causes the load units L and the relay control unit 42 in the drive state to enter the drive state (low-power state).

The fuse box 20 is used to block a current flow path when an overcurrent flows. The fuse box 20 is provided between the power supply box 40 and the load unit L and includes a plurality of fuses 21 to 25. Each of the plurality of fuses 21 to 25 includes a conductive fusible body with a low melting point. The fusible body fuses when an overcurrent flows from the power supply box 40 to the load units L. The plurality of fuses 21 to 25 interrupts electrical connection between the power supply box 40 and the load units L (L1 to L5) by fusing the fusible bodies.

The battery sensor 30 detects the charge level (SOC: State Of Charge) of the battery B. For example, the battery sensor 30 detects the charge level of the battery B on the basis of voltage of the battery B. The charge level becomes relatively high when the voltage of the battery B is relatively high, and becomes relatively low when the voltage of the battery B is relatively low. A method of detecting the charge level used by the battery sensor 30 is not limited to the above method, and the charge level may be detected on the basis of, for example, a current flowing into the battery B and a current flowing out of the battery B, instead. The battery sensor 30 is connected to the power supply box 40 and outputs a detection result indicating the charge level to the power supply box 40.

The power supply box 40 passes or interrupts the current flowing from the battery B to the load units L. The power supply box 40 includes a relay 41, the relay control unit 42, and a power supply line 43.

The relay 41 passes or interrupts the current and is a single-stable relay that is turned on only while the current is flowing. The relay 41 is provided between the battery B and the load units L and configured to be able to interrupt the power supplied from the battery B to the load units L. The relay 41 includes a contact portion 411 and a coil portion 412.

The contact portion 411 includes a first contact 411a and a second contact 411b. The first contact 411a is connected to a positive electrode of the battery B, and the second contact 411b is connected to the load units L through the fuse box 20.

The coil portion 412 turns on and off the contact portion 411. The coil portion 412 includes an iron core and a coil wound around the iron core. One end of the coil is connected to a connection line between the first contact 411a of the contact portion 411 and the positive electrode of the battery B, and another end of the coil is connected to the relay control unit 42. The coil portion 412 is then excited by the power supplied from the battery B to close the first contact 411a and the second contact 411b and turn on the contact portion 411. In addition, when the power supplied from the battery B is interrupted, the coil portion 412 opens the first contact 411a and the second contact 411b to turn off the contact portion 411.

The relay control unit 42 controls the power supplied from the battery B to the load units L and includes a control switch 421. The control switch 421 includes a first contact 421a and a second contact 421b. The first contact 421a is connected to the other end of the coil of the coil portion 412, and the second contact 421b is connected to ground.

In the standby mode, the relay control unit 42 controls the relay 41 to switch the power mode on the basis of the charge level of the battery B detected by the battery sensor 30 and the dark current interruption threshold Th. When the charge level of the battery B is lower than or equal to the threshold Th in the standby mode, for example, the relay control unit 42 turns off the relay 41 to interrupt the dark current flowing from the battery B to the load units L and the control unit M and switch from the standby mode to the interruption mode. More specifically, when the charge level of the battery B is lower than or equal to the threshold Th in the standby mode, the relay control unit 42 turns off the control switch 421 to interrupt the power supplied to the coil portion 412 of the relay 41, and opens the contact portion 411 of the relay 41 to interrupt the dark current flowing from the battery B to the load units L and the control unit M.

When the charge level of the battery B exceeds the threshold Th in the standby mode, on the other hand, the relay control unit 42 keeps the relay 41 turned on to cause the dark current to flow from the battery B to the load units L and the control unit M and maintain the standby mode. More specifically, when the charge level of the battery B exceeds the threshold Th in the standby mode, the relay control unit 42 keeps the control switch 421 turned on to continue the supply of power to the coil portion 412 of the relay 41, and keeps the contact portion 411 of the relay 41 closed to cause the dark current to flow from the battery B to the load units L and the control unit M.

The power supply line 43 is an electric wire for supplying power to the relay control unit 42. One end of the power supply line 43 is connected to a connection line between the relay 41 and the load units L, and another end is connected to the relay control unit 42. When the relay control unit 42 turns on the relay 41, the battery B supplies power to the relay control unit 42 through the power supply line 43. When the relay control unit 42 turns off the relay 41, the power supplied to the relay control unit 42 through the power supply line 43 is interrupted.

The switch mechanism 50 switches the power mode separately from the switching of the power mode by the control unit M. The switch mechanism 50 is provided in an instrument panel P of the vehicle, for example, and disposed at such a position that an occupant of the vehicle can operate the switch mechanism 50. The switch mechanism 50 is a mechanical switch pressed by an occupant and is, for example, a pushbutton switch. The switch mechanism 50 includes a first contact 51 and a second contact 52. The first contact 51 is connected to a connection line between the coil portion 412 and the control switch 421, and the second contact 52 is connected to the ground. When pressed by the occupant, the switch mechanism 50 closes and turns on the first contact 51 and the second contact 52 and maintains the closed state. When pressed again by the occupant in the closed state, the switch mechanism 50 opens and turns off the first contact 51 and the second contact 52 and maintains the open state. The switch mechanism 50 is thus an alternate switch capable of maintaining the closed state.

When the switch mechanism 50 is pressed and turned on by the occupant in the interruption mode, for example, the switch mechanism 50 excites the coil portion 412 of the relay 41 without the control performed by the relay control unit 42 to turn on the relay 41 after the interruption, cause the dark current to flow from the battery B to the load units L and the control unit M, and switch from the interruption mode to the standby mode. After switching from the interruption mode to the standby mode, the occupant turns on the ignition switch to start the vehicle. When the ignition switch is turned on, the power supply control unit 10 switches from the standby mode to the drive mode to cause the drive current to flow from the battery B to the load units L and the control unit M. When the switch mechanism 50 is pressed and turned off by the occupant after the switch from the standby mode to the drive mode, the switch mechanism 50 interrupts a current branching from the coil of the coil portion 412 to the switch mechanism 50.

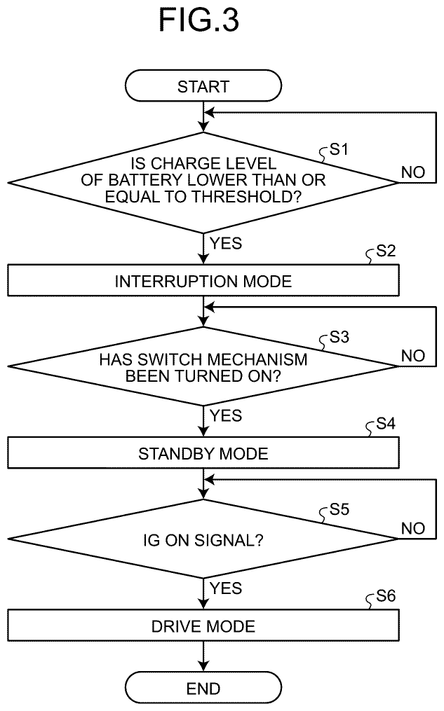

Next, an example of operations performed by the power supply control device 1 will be described. It is assumed here that the ignition switch has been turned off and the standby mode has been established. As illustrated in FIG. 3, the relay control unit 42 of the power supply control device 1 determines whether the charge level of the battery B is lower than or equal to the threshold Th (step S1). When the charge level of the battery B is lower than or equal to the threshold Th (step S1; Yes), the relay control unit 42 switches from the standby mode to the interruption mode (step S2). For example, the relay control unit 42 turns off the control switch 421 to interrupt the power supplied to the coil portion 412 of the relay 41 and opens the contact portion 411 of the relay 41 to interrupt the dark current flowing from the battery B to the load units L and the control unit M and switch from the standby mode to the interruption mode. When pressed and turned on by the occupant after the switch mechanism 50 is switched to the interruption mode (step S3; Yes), the switch mechanism 50 switches from the interruption mode to the standby mode (step S4). When the switch mechanism 50 is pressed and turned on by the occupant, for example, the switch mechanism 50 excites the coil portion 412 of the relay 41 without the control performed by the relay control unit 42 to turn on the relay 41 after the interruption, cause the dark current to flow from the battery B to the load units L and the control unit M, and switch from the interruption mode to the standby mode. Next, if the power supply control unit 10 receives an IG on signal (step S5; Yes), the power supply control unit 10 switches from the standby mode to the drive mode. Upon receiving the IG on signal, for example, the power supply control unit 10 activates the load units L and the relay control unit 42 in the standby state to establish the drive state, and ends the process.

If the charge level of the battery B exceeds the threshold Th in step S1 described above (step S1; Yes), the relay control unit 42 again determines whether the charge level of the battery B is lower than or equal to the threshold Th. In step S3 described above, after the switch mechanism 50 is switched to the interruption mode, the switch mechanism 50 waits until pressed and turned on by the occupant (step S3; No). In step S5 described above, if the power supply control unit 10 does not receive an IG on signal (step S5; No), the power supply control unit 10 waits until receiving an IG on signal.

As described above, the power supply control device 1 according to the embodiment includes the control unit M, the relay 41, the battery sensor 30, and the switch mechanism 50. The control unit M switches the power mode and controls the power supplied from the battery B mounted on the vehicle to the load units L. The relay 41 is provided between the battery B and the load units L and capable of interrupting the power supplied from the battery B to the load units L. The battery sensor 30 detects the charge level of the battery B. The switch mechanism 50 switches the power mode separately from the switching of the power mode by the control unit M. Here, as the switching of the power mode, the control unit M is switchable between the drive mode, in which the drive current for driving the load units L and the control unit M flows from the battery B to the load units L and the control unit M, the standby mode, in which the drive current is interrupted and the dark current flows from the battery B to the load units L and the control unit M, and the interruption mode, in which the dark current flowing from the battery B to the load units L and the control unit M is interrupted. When the charge level of the battery B detected by the battery sensor 30 is lower than or equal to the predetermined dark current interruption threshold Th in the standby mode, the relay control unit 42 of the control unit M switches the relay 41 to interrupt the dark current flowing from the battery B to the load units L and the control unit M and switch from the standby mode to the interruption mode. When the switch mechanism 50 is pressed and turned on in the interruption mode, the switch mechanism 50 switches the relay 41 after the interruption without the control performed by the control unit M to cause the dark current to flow from the battery B to the load units L and the control unit M and switch from the interruption mode to the standby mode.

With this configuration, the power supply control device 1 is capable of inhibiting the charge level of the battery B from becoming zero since, when the charge level of the battery B is lower than or equal to the dark current interruption threshold Th, the dark current flowing from the battery B to the load units L and the control unit M is interrupted. That is, since the power supply control device 1 interrupts the dark current, a period until the battery B dies can be extended. Since the power supply control device 1 also interrupts the dark current flowing to the control unit M at this time, waste of the dark current can be inhibited. When the switch mechanism 50 is pressed and turned on by the occupant, the power supply control device 1 causes the dark current to flow from the battery B to the load units L and the control unit M, so that the vehicle can be started. The power supply control device 1 can thus appropriately control the power supply.

In the power supply control device 1, the control unit M includes the power supply control unit 10 that switches from the drive mode to the standby mode and the relay control unit 42 that switches from the standby mode to the interruption mode. The relay 41 includes the contact portion 411 and the coil portion 412. In the contact portion 411, the first contact 411a is connected to the positive electrode of the battery B, and the second contact 411b is connected to the load units L and turned on and off. The coil portion 412 has one end connected to the connection line between the first contact 411a of the contact portion 411 and the positive electrode of the battery B and the other end connected to the relay control unit 42, and is excited by the power supplied from the battery B to turn on the contact portion 411. The relay control unit 42 includes the control switch 421. In the control switch 421, the first contact 421a is connected to the other end of the coil portion 412, and the second contact 421b is connected to the ground. Power is supplied to the relay control unit 42 from the battery B through the power supply line 43. One end of the power supply line 43 is connected to a connection line between the relay 41 and the load units L, and another end is connected to the relay control unit 42. In the switch mechanism 50, the first contact 51 is connected to the connection line between the coil portion 412 and the control switch 421, and the second contact 52 is connected to the ground.

With this configuration, when the charge level of the battery B is lower than or equal to the threshold Th in the standby mode, the power supply control device 1 can turn off the control switch 421 to interrupt the power supplied to the coil portion 412 of the relay 41 and open the contact portion 411 of the relay 41 to interrupt the dark current flowing from the battery B to the load units L and the control unit M and switch from the standby mode to the interruption mode. When the switch mechanism 50 is pressed and turned on in the interruption mode thereafter, the power supply control device 1 can excite the coil portion 412 of the relay 41 without the control performed by the relay control unit 42 to turn on the relay 41 after the interruption, cause the dark current to flow from the battery B to the load units L and the control unit M, and switch from the interruption mode to the standby mode.

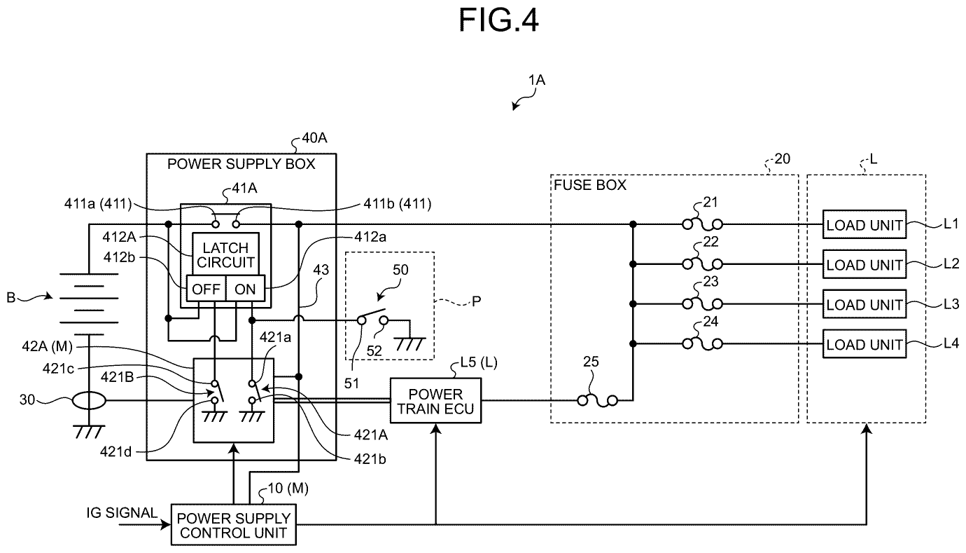

Next, a modification of the embodiment will be described. In the modification, constituent elements equivalent to those in the embodiment will be given the same reference numerals, and detailed description thereof is omitted. FIG. 4 is a block diagram illustrating an example of configuration of a power supply control device 1A according to the modification of the embodiment. The power supply control device 1A illustrated in FIG. 4 is different from the power supply control device 1 according to the embodiment in that the power supply control device 1A includes a latch relay 41A.

The latch relay 41A is a latching-type relay that passes or interrupts a current and that can be switched on and off by a pulse current. The latch relay 41A is provided between the battery B and the load units L and configured to be able to interrupt the power supplied from the battery B to the load units L. The latch relay 41A includes a contact portion 411 and a latch circuit 412A.

The latch circuit 412A turns on and off the contact portion 411 and includes a first coil portion 412a and a second coil portion 412b.

The first coil portion 412a includes an iron core and a coil wound around the iron core. One end of the coil is connected to the connection line between the first contact 411a of the contact portion 411 and the positive electrode of the battery B, and another end of the coil is connected to a relay control unit 42A. The first coil portion 412a is then excited by the power supplied from the battery B to close the first contact 411a and the second contact 411b and turn on the contact portion 411.

The second coil portion 412b includes an iron core and a coil wound around the iron core. One end of the coil is connected to the connection line between the first contact 411a of the contact portion 411 and the positive electrode of the battery B, and another end of the coil is connected to the relay control unit 42A. The second coil portion 412b is then excited by the power supplied from the battery B to open the first contact 411a and the second contact 411b and turn off the contact portion 411.

The relay control unit 42A controls the power supplied from the battery B to the load units L and includes a first control switch 421A and a second control switch 421B. The first control switch 421A includes a first contact 421a and a second contact 421b. The first contact 421a is connected to the other end of the coil of the first coil portion 412a, and the second contact 421b is connected to the ground. The second control switch 421B includes a first contact 421c and a second contact 421d. The first contact 421c is connected to the other end of the coil of the second coil portion 412b, and the second contact 421d is connected to the ground.

In the standby mode, the relay control unit 42A controls the relay 41 to switch the power mode on the basis of the charge level of the battery B detected by the battery sensor 30 and the dark current interruption threshold Th. When the charge level of the battery B is lower than or equal to the threshold Th in the standby mode, for example, the relay control unit 42A turns off the latch relay 41A to interrupt the dark current flowing from the battery B to the load units L and the control unit M and switch from the standby mode to the interruption mode. More specifically, when the charge level of the battery B is lower than or equal to the threshold Th in the standby mode, the relay control unit 42A turns on the second control switch 421B to supply power (pulse current) to the second coil portion 412b of the latch relay 41A, and opens the contact portion 411 of the relay 41 to interrupt the dark current flowing from the battery B to the load units L and the control unit M.

When the charge level of the battery B exceeds the threshold Th in the standby mode, on the other hand, the relay control unit 42A keeps the latch relay 41A turned on to cause the dark current to flow from the battery B to the load units L and the control unit M and maintain the standby mode.

The switch mechanism 50 includes a first contact 51 and a second contact 52. The first contact 51 is connected to a connection line between the first coil portion 412a and the first control switch 421A, and the second contact 52 is connected to the ground. When the switch mechanism 50 is pressed and turned on in the interruption mode, the switch mechanism 50 excites the first coil portion 412a of the latch relay 41A without the control performed by the relay control unit 42A to turn on the latch relay 41A after the interruption, cause the dark current to flow from the battery B to the load units L and the control unit M, and switch from the interruption mode to the standby mode.

As described above, the power supply control device 1A according to the modification includes the latch relay 41A. The latch relay 41A includes a contact portion 411 and a latch circuit 412A. The latch circuit 412A includes the first coil portion 412a and the second coil portion 412b. In the contact portion 411, the first contact 411a is connected to the positive electrode of the battery B, and the second contact 411b is connected to the load units L and turned on and off. The first coil portion 412a has one end connected to the connection line between the first contact 411a of the contact portion 411 and the positive electrode of the battery B and the other end connected to the relay control unit 42A, and is excited by the power supplied from the battery B to turn on the contact portion 411. The second coil portion 412b has one end connected to the connection line between the first contact 411a of the contact portion 411 and the positive electrode of the battery B and the other end connected to the relay control unit 42A, and is excited by the power supplied from the battery B to turn on the contact portion 411. The relay control unit 42A includes the first control switch 421A and the second control switch 421B. In the first control switch 421A, the first contact 421a is connected to the other end of the first coil portion 412a, and the second contact 421b is connected to the ground. In the second control switch 421B, the first contact 421c is connected to the other end of the second coil portion 412b, and the second contact 421d is connected to the ground. Power is supplied to the relay control unit 42A from the battery B through the power supply line 43. One end of the power supply line 43 is connected to the connection line between the latch relay 41A and the load units L, and the other end is connected to the relay control unit 42A. In the switch mechanism 50, the first contact 51 is connected to the connection line between the first coil portion 412a and the first control switch 421A, and the second contact 52 is connected to the ground.

With this configuration, when the charge level of the battery B is lower than or equal to the threshold Th in the standby mode, the power supply control device 1A can turn off the second control switch 421B to supply power supplied to the second coil portion 412b of the latch relay 41A and open the contact portion 411 of the latch relay 41A to interrupt the dark current flowing from the battery B to the load units L and the control unit M and switch from the standby mode to the interruption mode. When the switch mechanism 50 is pressed and turned on in the interruption mode thereafter, the power supply control device 1A excites, with a pulse current, the first coil portion 412a of the latch relay 41A without the control performed by the relay control unit 42A to turn on the latch relay 41A after the interruption, cause the dark current to flow from the battery B to the load units L and the control unit M, and switch from the interruption mode to the standby mode. As a result, since the power supply control device 1A can turn on the latch relay 41A with the pulse current without continuing to flow a current, power consumption can be reduced compared to the power supply control device 1 according to the embodiment.

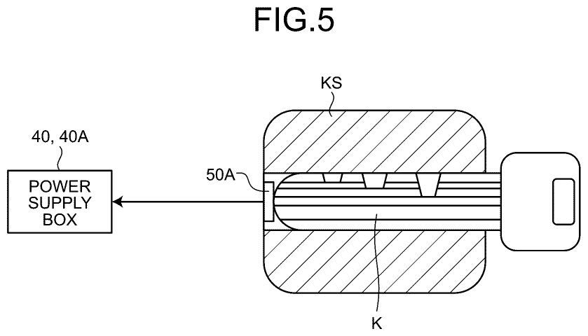

Next, a switch mechanism 50A according to another modification of the embodiment will be described. FIG. 5 is a diagram illustrating an example of configuration of the switch mechanism 50A according to the modification of the embodiment. The switch mechanism 50A is different from the alternate switch mechanism 50 according to the embodiment in that the switch mechanism 50A is a momentary (automatic return) switch.

As illustrated in FIG. 5, the switch mechanism 50A is provided in a key cylinder KS into which a vehicle key K is inserted. The switch mechanism 50A is provided, for example, in the key cylinder KS into which the key K is inserted when the ignition switch is turned on, and is disposed at a position facing a tip of the key K. That is, the switch mechanism 50A is disposed at a bottom of the key cylinder KS in an insertion direction of the key K. When the key K is inserted into the key cylinder KS in the interruption mode, the switch mechanism 50A is pressed and turned on by the tip of the key K to turn on the latch relay 41A after the interruption without the control performed by the control unit M (the power supply control unit 10 and the relay control unit 42A), cause the dark current to flow from the battery B to the load units L and the control unit M, and switch from the interruption mode to the standby mode. After switching from the interruption mode to the standby mode, the occupant of the vehicle turns the key K to turn on the ignition switch and start the vehicle. When the ignition switch is turned on, the power supply control unit 10 switches from the standby mode to the drive mode to cause the drive current to flow from the battery B to the load units L and the control unit M.

As described above, the switch mechanism 50A according to the modification is provided in the key cylinder KS into which the key K of the vehicle is inserted. When the key K is inserted into the key cylinder KS, the switch mechanism 50A is pressed and turned on by the key K to switch the latch relay 41A after interruption without the control performed by the control unit M. With this configuration, in the interruption mode, the power supply control device 1 can shift from the interruption mode to the standby mode without causing the occupant of the vehicle to be aware that the dark current is interrupted. As a result, the power supply control device 1 can eliminate the trouble of the occupant of the vehicle to shift from the interruption mode to the standby mode, that is, a user-friendly power supply control device 1 can be provided.

Although an example in which the switch mechanism 50 is provided in the instrument panel P has been described and an example in which the switch mechanism 50A is provided in the key cylinder KS has been described in the above description, a position at which the switch mechanism 50 or 50A is provided is not limited to these, and the switch mechanism 50 or 50A may be provided at another position, instead.

Although an example in which the power supply line 43 is provided inside the power supply box 40 or 40A has been described, a position at which the power supply line 43 is provided is not limited these, and the power supply line 43 may be provided outside the power supply box 40 or 40A and supply power from the outside to the relay control unit 42 or 42A, instead.

A power supply control device according to the present embodiment is capable of inhibiting a charge level of a battery from becoming zero because when the charge level of the battery is lower than or equal to a dark current interruption threshold, a dark current flowing from the battery to load units and a control unit is interrupted. Since the power supply control device also interrupts the dark current flowing to the control unit at this time, waste of the dark current can be inhibited. When a switch mechanism is pressed and turned on, the power supply control device causes a dark current to flow from the battery to the load units and the control unit, so that the vehicle can be started. The power supply control device can thus appropriately control the power supply.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A power supply control device comprising:
a control unit that is configured to control power supplied from a battery mounted on a vehicle to a load unit by switching a power mode;
a relay that is provided between the battery and the load unit and that is capable of interrupting power supplied from the battery to the load unit;
a detection unit that detects a charge level of the battery; and
a switch mechanism that switches the power mode separately from the switching of the power mode by the control unit, wherein
the control unit is switchable between, as the switching of the power mode, a drive mode, in which a drive current for driving the load unit and the control unit flows from the battery to the load unit and the control unit, a standby mode, in which the drive current is interrupted and a dark current flows from the battery to the load unit and the control unit, and an interruption mode, in which the dark current flowing from the battery to the load unit and the control unit is interrupted, and, in a case where the charge level of the battery detected by the detection unit is lower than or equal to a predetermined dark current interruption threshold in the standby mode, the control unit switches the relay to interrupt the dark current flowing from the battery to the load unit and the control unit and switches from the standby mode to the interruption mode, and
when pressed and turned on in the interruption mode, the switch mechanism switches the relay after the interruption without the control performed by the control unit to cause the dark current to flow from the battery to the load unit and the control unit and switch from the interruption mode to the standby mode.

2. The power supply control device according to claim 1, wherein
the switch mechanism is provided in a key cylinder into which a key of the vehicle is inserted and, when the key is inserted into the key cylinder, the switch mechanism is pressed and turned on by the key to switch the relay after the interruption without the control performed by the control unit.

3. The power supply control device according to claim 1, wherein
the control unit includes a power supply control unit that switches from the drive mode to the standby mode, and a relay control unit that switches from the standby mode to the interruption mode,
the relay includes a contact portion having a first contact and a second contact, the first contact is connected to a positive electrode of the battery and the second contact is connected to the load unit and turned on and off, and a coil portion having a first end and a second end, the first end is connected to a connection line between the first contact of the contact portion and the positive electrode of the battery and the second end is connected to the relay control unit, and the coil portion is excited by power supplied from the battery to turn on the contact portion,
the relay control unit includes a control switch having a first contact and a second contact, the first contact is connected to the second end of the coil portion and the second contact is connected to ground, and the relay control unit receives power supplied from the battery through a power supply line whose one end is connected to a connection line between the relay and the load unit and whose another end is connected to the relay control unit, and
a first contact of the switch mechanism is connected to a connection line between the coil portion and the control switch and a second contact of the switch mechanism is connected to the ground.

4. The power supply control device according to claim 2, wherein
the control unit includes a power supply control unit that switches from the drive mode to the standby mode, and a relay control unit that switches from the standby mode to the interruption mode,
the relay includes a contact portion having a first contact and a second contact, the first contact is connected to a positive electrode of the battery and the second contact is connected to the load unit and turned on and off, and a coil portion having a first end and a second end, the first end is connected to a connection line between the first contact of the contact portion and the positive electrode of the battery and the second end is connected to the relay control unit, and the coil portion is excited by power supplied from the battery to turn on the contact portion,
the relay control unit includes a control switch having a first contact and a second contact, the first contact is connected to the second end of the coil portion and the second contact is connected to ground, and the relay control unit receives power supplied from the battery through a power supply line whose one end is connected to a connection line between the relay and the load unit and whose another end is connected to the relay control unit, and
a first contact of the switch mechanism is connected to a connection line between the coil portion and the control switch and a second contact of the switch mechanism is connected to the ground.

5. The power supply control device according to claim 1, wherein
the control unit includes a power supply control unit that switches from the drive mode to the standby mode, and a relay control unit that switches from the standby mode to the interruption mode,
the relay includes a contact portion having a first contact and a second contact, the first contact is connected to a positive electrode of the battery and the second contact is connected to the load unit and turned on and off, and a latch circuit including a first coil portion whose one end is connected to a connection line between the first contact of the contact portion and the positive electrode of the battery and whose another end is connected to the relay control unit and that is excited by power supplied from the battery to turn on the contact portion, and a second coil portion whose one end is connected to the connection line between the first contact of the contact portion and the positive electrode of the battery and whose another end is connected to the relay control unit and that is excited by the power supplied from the battery to turn off the contact portion,
the relay control unit includes a first control switch having a first contact and a second contact, the first contact is connected to the another end of the first coil portion and the second contact is connected to ground, and a second control switch having a first contact and a second contact, the first contact is connected to the another end of the second coil portion and the second contact is connected to the ground, and the relay control unit receives power supplied from the battery through a power supply line whose one end is connected to a connection line between the relay and the load unit and whose another end is connected to the relay control unit, and
a first contact of the switch mechanism is connected to a connection line between the first coil portion and the first control switch and a second contact of the switch mechanism is connected to the ground.

6. The power supply control device according to claim 2, wherein
the control unit includes a power supply control unit that switches from the drive mode to the standby mode, and a relay control unit that switches from the standby mode to the interruption mode,
the relay includes a contact portion having a first contact and a second contact, the first contact is connected to a positive electrode of the battery and the second contact is connected to the load unit and turned on and off, and a latch circuit including a first coil portion whose one end is connected to a connection line between the first contact of the contact portion and the positive electrode of the battery and whose another end is connected to the relay control unit and that is excited by power supplied from the battery to turn on the contact portion, and a second coil portion whose one end is connected to the connection line between the first contact of the contact portion and the positive electrode of the battery and whose another end is connected to the relay control unit and that is excited by the power supplied from the battery to turn off the contact portion,
the relay control unit includes a first control switch having a first contact and a second contact, the first contact is connected to the other end of the first coil portion and the second contact is connected to ground, and a second control switch having a first contact and a second contact, the first contact is connected to the other end of the second coil portion and the second contact is connected to the ground, and the relay control unit receives power supplied from the battery through a power supply line whose one end is connected to a connection line between the relay and the load unit and whose another end is connected to the relay control unit, and
a first contact of the switch mechanism is connected to a connection line between the first coil portion and the first control switch and a second contact of the switch mechanism is connected to the ground.
